(19) United States
(12) Patent Application Publication
(10) Pub. No.: US 2024/0230948 A1
(43) Pub. Date: Jul. 11, 2024

(54) Correlating Stratigraphic Sequences in a Subsurface Formation

(71) Applicant: Saudi Arabian Oil Company, Dhahran (SA)

(72) Inventors: Farrukh Qayyum, Dhahran (SA); Abdullah A. Theyab, Dhahran (SA); Raied Al Sadan, Dhahran (SA)

(21) Appl. No.: 18/150,439

(22) Filed: Jan. 5, 2023

(51) Int. Cl. G01V 11/00; E21B 49/00

(52) U.S. Cl. CPC G01V 11/002; E21B 49/00

(57) ABSTRACT

Methods and devices for correlating stratigraphic sequences in a subsurface formation include: measuring a property of a subsurface formation at a plurality of wells using a logging tool; and generating a predicted trend log from the well log for the well. Generating the predicted trend log includes: selecting a set of maximum values and a set of minimum values using a sliding window; computing a set of mean values of the property; estimating a mean drift trend based on the set of mean values and the values of the property; configuring a recursive filter; and convolving the recursive filter to obtain a relative trend log.

### TECHNICAL FIELD

This disclosure generally relates to mapping a subsurface formation.

### BACKGROUND

Stratigraphy is a branch of geology concerned with the study of rock layers (strata) and layering (stratification). Sequence stratigraphy is the study of sedimentary rock relationships within a chronostratigraphic framework.

Sequence stratigraphy has become a popular methodology for correlating sedimentary strata and constructing a quasi-chronostratigraphic framework for a basin, as it is a powerful tool for predicting the spatial and temporal distribution of reservoir, source, and seal rocks within a stratigraphic interval, at both the exploration and the reservoir scales. It assists in defining the architecture and the grand design of a depositional system based on base-level and/or sea-level variations in a basin.

### SUMMARY

This specification describes systems and methods for sequence stratigraphic correlation using predicted trend logs. The predicted trend logs can be based on wireline log data from a subsurface formation. These systems and methods help identify and extract geologic patterns (e.g., aggradation, transgressive, regressive) from well logs.

In one aspect, a method for correlating stratigraphic sequences in a subsurface formation includes: measuring a property of the subsurface formation at a plurality of wells using a logging tool; storing values of the measured property in a well log for each well of the plurality of wells; for each well of the plurality of wells, generating a predicted trend log from the well log for that well, the generating including: selecting, based on a sliding window, a set of maximum values and a set of minimum values of the property in the well log; computing, based on the set of maximum values and the set of minimum values, a set of mean values of the property; estimating, based on the set of mean values and the values of the property in the well log, a mean drift trend; configuring a recursive filter, the configuring based on a least squares fit of the set of mean values and the values of the property in the well log; calculating a relative trend log by convolving the recursive filter with the mean drift trend; and calculating a predicted trend log by integrating and normalizing the relative trend log; and rendering, on a user interface, a cross-section of the subsurface formation that is based on the predicted trend logs for the plurality of wells rendering, on a user interface, a cross-section of the subsurface formation based on the predicted trend logs for the plurality of wells.

In one aspect, one or more non-transitory computer-readable media storing instructions for correlating stratigraphic sequences in a subsurface formation, the instructions executable by at least one processor to cause the at least one processor to perform operations including: accessing, from a data store, values of a measured property of a well log, the values being accessed for each well of a plurality of wells; for each well of the plurality of wells, generating a predicted trend log from the well log for that well, the generating includes: selecting, based on a sliding window, a set of maximum values and a set of minimum values of the property in the well log; computing, based on the set of maximum values and the set of minimum values, a set of mean values of the property; estimating, based on the set of mean values and the values of the property in the well log, a mean drift trend; configuring a recursive filter, the configuring based on a least squares fit of the set of mean values and the values of the property in the well log; calculating a relative trend log by convolving the recursive filter with the mean drift trend; and calculating a predicted trend log by integrating and normalizing the relative trend log; and rendering, on a user interface, a cross-section of the subsurface formation that is based on the predicted trend logs for the plurality of wells.

In some embodiments of the aspects, the generating further includes smoothing the set of maximum values and the set of minimum values before computing the set of mean values for wells of the plurality. In some cases, the smoothing includes using a one dimensional gaussian filter.

In some embodiments, the property is a facies-dependent property. In some cases, the logging tool includes a spectral or gamma ray logging tool. In some cases, the well log includes a spectral or gamma ray well log. In some cases, the well log includes resistivity, sonic data, or both.

In some embodiments of the aspects, the generating further includes applying a de-spiking algorithm to the values of the property in the well log.

In some embodiments, the aspects further include identifying correlations between predicted trend logs of the plurality of wells.

Certain implementations of these systems and methods may have particular advantages. In some implementations, this approach can relate rocks with similar facies associations and build a sequence stratigraphic framework, which is an organization of sedimentary units in time and space. In some implementations, this approach can identify hidden geologic trends when correlating multiple wells within a basin.

The details of one or more embodiments of these systems and methods are set forth in the accompanying drawings and the description below. Other features, objects, and advantages of this approach will be apparent from the description and drawings, and from the claims.

### DESCRIPTION OF DRAWINGS

FIG. 1 is a schematic view of subsurface formation.

FIG. 2 is an example flow diagram of a method to generate a predicted trend log.

FIG. 3 is a combination plot illustrating steps of an example implementation of a method to generate a predicted trend log.

FIG. 4 shows the results of an example implementation of the method to generate predicted trend logs across several wells in a subsurface formation.

FIGS. 5A-5B show a comparison between a conventional method and an example implementation of the method to generate predicted trend logs for a highstand carbonate shelf.

FIG. 6 shows an example gamma ray log demonstrating conventional methods of utilizing wireline log data.

FIG. 7 is a block diagram illustrating an example computer system used to provide computational functionalities associated with described algorithms, methods, functions, processes, flows, and procedures according to some implementations of the present disclosure.

Like reference symbols in the various drawings indicate like elements.

### DETAILED DESCRIPTION

This specification describes systems and methods for sequence stratigraphic correlation using predicted trend logs. The predicted trend logs can be based on wireline log data from a subsurface formation. These systems and methods help identify and extract geologic patterns (e.g., aggradation, transgressive, regressive) from well logs. The predicted trend logs provide a tool to guide interpreters to find consistent and unique patterns that are relatable and mappable over an entire basin. The patterns can be further evaluated with various sequence stratigraphic principles.

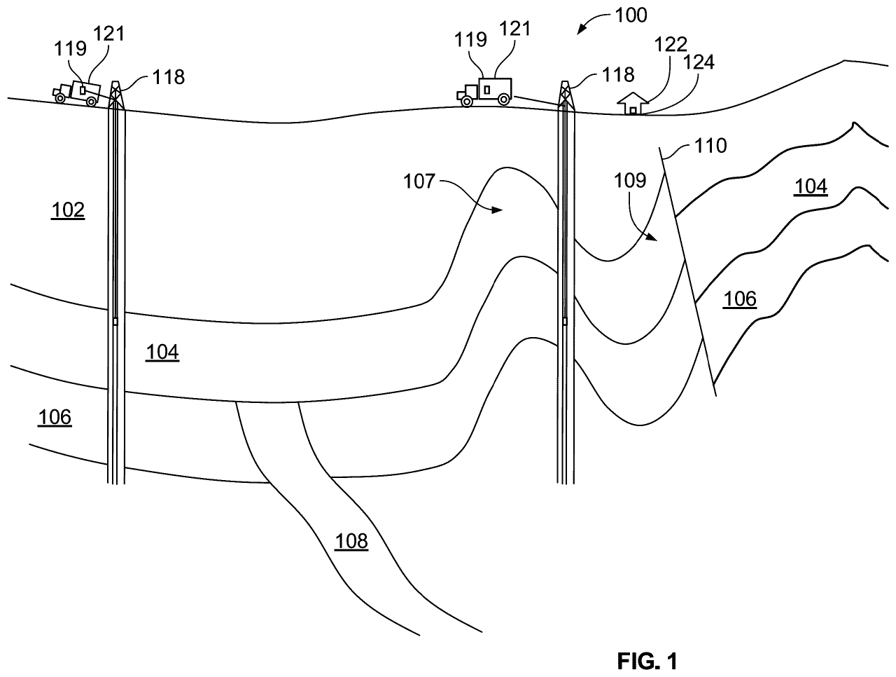

FIG. 1 is a schematic view of a subsurface formation with features such as facies and faults in the subsurface formation 100. Methods of measuring the properties of the source rock within the subterranean formation include drilling wells and logging data measured from a borehole, such as gamma radiation wireline logging. Well logging can occur across the lifetime of the well including during drilling, completing, producing or abandoning. The subterranean formation 100 includes a layer of impermeable cap rock 102 at the surface. Facies underlying the impermeable cap rocks 102 include a sandstone layer 104, a limestone layer 106, and a sand layer 108. A fault line 110 extends across the sandstone layer 104 and the limestone layer 106.

Oil and gas tend to rise through permeable reservoir rock until further upward migration is blocked, for example, by the layer of impermeable cap rock 102. Seismic surveys attempt to identify locations where interaction between layers of the subterranean formation 100 are likely to trap oil and gas by limiting this upward migration. For example, FIG. 1 shows an anticline trap 107, where the layer of impermeable cap rock 102 has an upward convex configuration, and a fault trap 109, where the fault line 110 might allow oil and gas to flow in with clay material between the walls trapping the petroleum. Other traps include salt domes and stratigraphic traps.

One or more wells 118 can be drilled into the subsurface formation 100. A control center 122 can be operatively coupled to a well logging unit 121 and other data acquisition and wellsite systems. The control center 122 may have computer facilities for receiving, storing, processing, and analyzing data from the well logging unit 121 and other data acquisition and wellsite systems that provide additional information about the subterranean formation. For example, the control center 122 can receive data from a computer 119 associated with a well logging unit 121. For example, computer systems 124 in the control center 122 can be configured to analyze, model, control, optimize, or perform management tasks of field operations associated with development and production of resources such as oil and gas from the subterranean formation 100. Alternatively, the computer systems 124 can be located in a different location than the control center 122. Some computer systems are provided with functionality for manipulating and analyzing the data, such as performing seismic interpretation or borehole resistivity image log interpretation to identify geological surfaces in the subterranean formation or performing simulation, planning, and optimization of production operations of the wellsite systems.

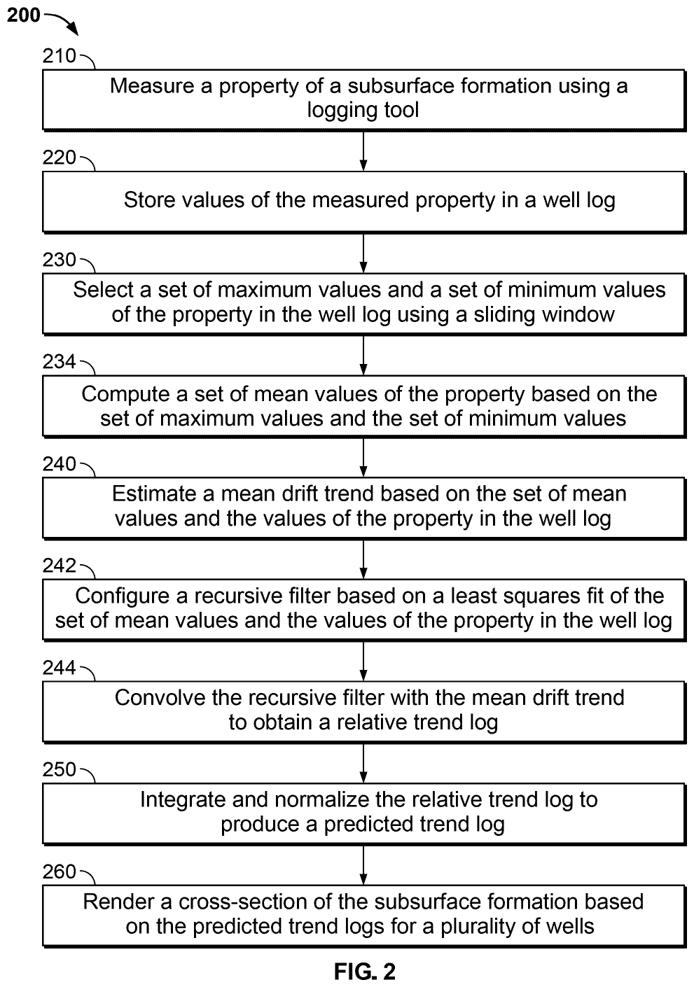

FIG. 2 shows an example flow diagram for a method 200 to generate a predicted trend log (PTL) based on a facies sensitive log of a property of the subsurface formation from an individual well. These predicted logs provide identifiable patterns to establish a unified stratigraphic correlation between wells.

A property of a subsurface formation is measured using a logging tool (step 210). The values of the measured property are stored in a well log (step 220) defining an input log, for example a spectral wireline log or a gamma radiation wireline log. The input log can be facies sensitive, and if the input log is facies sensitive, it should not be sensitive to noise or fluids within the subsurface formation such as hydrocarbons for sequence stratigraphic interpretation. If the input log is sensitive to noise or fluids within the subsurface formation, it may show the trends of fluid filled facies or diagenesis rather than the depositional trends of the formation. The input log can also be a log that contains a significant diagenetic overprint—because such an overprint character will carry a post-depositional process, which is important in stratigraphic correlation (pre- vs. post-depositional). The input log can also be a log of resistivity or sonic data to define lithofacies or pore-sensitive contacts. Such a practice may add value to gamma-ray driven sequence stratigraphic correlations. This may also lead towards local rather than global interpretation.

In some implementations, the input log is conditioned to remove erroneous spikes in the input log. The conditioning is done using a de-spiking algorithm (e.g. a windowed median filter, a guassian smoothing filter, or a moving average). De-spiking is performed to improve the reliability and consistency of the PTL.

Bounding extrema (e.g., maxima or minima) in the conditioned input log are found using an enveloping algorithm (step 230). The enveloping algorithm runs a sliding search window with a user-defined size (e.g., 5 or 10 samples) over the entire conditioned input log. The minimum value and maximum value of the conditioned wireline log within each search window are identified and stored. This gives a series of data points less than the input series. The output series data is then converted into a fixed sample series by interpolating the minima and maxima and storing them as new arrays of the same size as the input data The arrays of minimum and maximum values define an envelope that bounds the data in the input log.

A moderate smoothing can be applied to the stored minimum and maximum values in some implementations to have gradual changes in the low frequency trends. This can be done, for example, using a one-dimensional gaussian smoothing filter,

$$G ( x ) = \frac{1}{\sqrt{2 {πσ}^{2}}} {e}^{- {x}^{2} / 2 {σ}^{2}} . \qquad ( 1 )$$

where x is the given input data series or an array

The minimum value and maximum value arrays are averaged to calculate a mean trend line xₘ (step 234),

$${x}_{m} = \frac{{x}^{min} + {x}^{max}}{2} , \qquad ( 2 )$$

where xₘᵢₙ is the array defining the minimum of the given data, and x^{max} is the array defining the maximum of the given data. If smoothing is done, the mean trend line can be calculated using the smoothed minimum value array and the smoothed maximum value array.

If too narrow of a search window (e.g., 1 or 2 data samples) is selected in the enveloping operation, step 230, there can be little discrimination between the mean trend line and the input log. One aim of the enveloping is to preserve low frequency trends present in the input log and eliminate high-frequency trends. If the search window is too large (e.g. 100 or more data samples) the mean trend line may not follow the low or high frequency trends of the input log. An appropriately sized search window can preserve the low frequency trends of the data.

A mean drift trend is estimated based on the difference between the mean trend line calculated in step 234 and the input log data (step 240).

$${x}_{d , i} = {X}_{i} - {x}_{m , i} , \qquad ( 3 )$$

where x_{d,i} is the drift for the ith data point, Xᵢ is the ith data point from the input log, and X_{m,i} is the mean estimated for the ith data point from equation 2.

The mean trend line also goes through a filter design f(x) (step 242) such as a Yule-Walker kernel design. In the example of a Yule-Walker kernel design, a recursive filter is designed using a least squares fit and outputs filter coefficients. The designed filter is then convolved with the mean drift trend (Eq. 3) to obtain a relative trend log (step 244). The relative trend log is then numerically integrated and normalized (e.g., using standard normalization) to produce a predicted trend log (PTL) (step 250),

$$PTL = {\sum }_{i = 0}^{n} f ( x ) * {x}_{d , i} . \qquad ( 4 )$$

The PTL can then stored in a database in some implementations.

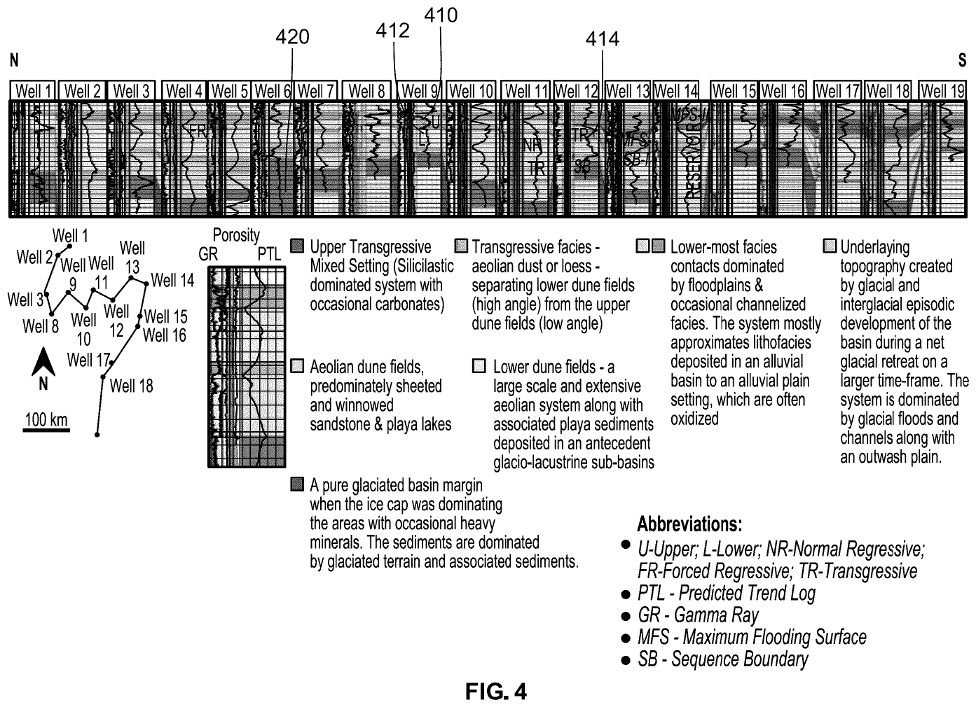

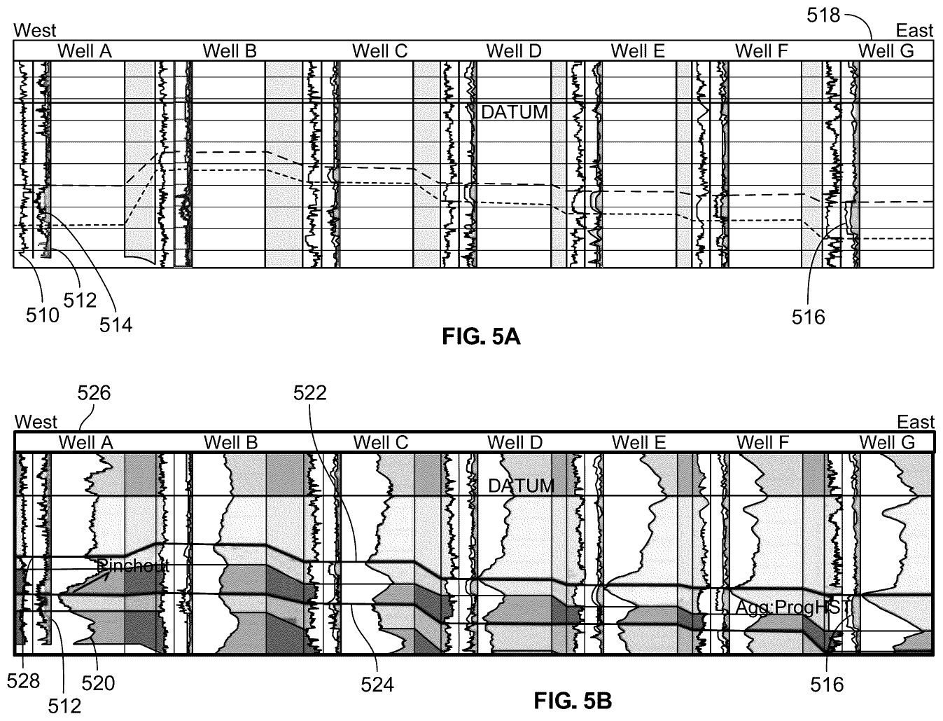

After one or more PTLs have been generated a cross-section of the subsurface formation can be rendered on a user interface based on the PTLs. The rendered PTLs can yield insights into the stratigraphy of a subsurface formation. FIGS. 4 and 5 show examples of rendered PTLs generated from well log data obtained at several wells within a subsurface formation.

PTLs generated from the method 200 are studied to establish a stratigraphic correlation and a sequence stratigraphic framework. Consistent log trends in a basin may correspond to a common geologic process that occurred on a regional and/or local scale. This synthesis can establish a relative geologic time per unit and further principles such as superpositioning can assist in establishing a hierarchical relationship between the sequences and/or sub-units of a sequence such as system tracts or parasequences. The sequence stratigraphic framework can be further integrated with three dimensional (3D) seismic data and biostratigraphic information for a unified interpretation. The predicted trend logs can have a broad application for the subsurface hydrocarbon exploration.

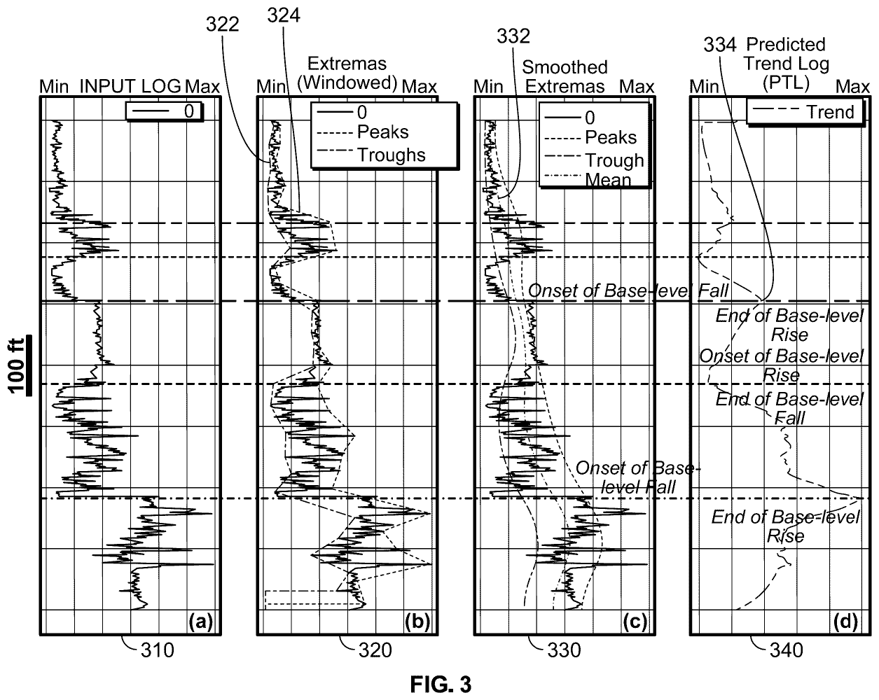

FIG. 3 shows a simplified composite plot illustrating an example implementation of the method 200 to generate a PTL based on an input log. The input log 310 is a standard gamma ray wireline log measured in a borehole in a subsurface formation. In each plot, the gamma-ray index increases from left to right. The second plot 320 shows the output of the enveloping process (step 230) where minimum values 322 and maximum values 324 are identified within a search window that slides over the data from the top to the bottom. The third plot 330 shows the result of the smoothing operation (step 232) where the maximum 324 and minimum 322 values are smoothed using a 1D Gaussian filtering. A mean trend line 332 is calculated based on the maximum and minimum values (step 234). This mean trend line 332 preserves the low frequency trend of the input log. The fourth plot 340 shows the resulting predicted trend line (PTL). The deflection of the data above and below the mean trend line 332 results in sharp inflection points 342 when convolved with a designed kernel. The rise and fall of the base level can be, for example, a rise and fall of a sea-level in marine settings or a rise-/fall- of a hypothetical level in a non-marine setting. The PTL can also show subordinate cycles within major cycles.

Further geologic insights can be attached to these patterns when studied in conjunction with biostratigraphic results for age controls. The extracted patterns can be cyclic and may repeat on a basin scale, whether locally or regionally, which subsequently can assist in developing stratigraphic sequences and subsets of stratigraphic sequences. Patterns from multiple drilled locations can give a hierarchical correlation to understand the depositional history of the subsurface formation.

FIG. 4 shows the results of an example implementation of the method 200 across several wells in a subsurface formation. This example shows a regional cross-section correlating an aeolian system and a glacio-fluvial system. The aeolian system shows two regressive drifts 410, 412 (leftward) on predicted trend logs with transgressive facies (TR) 414 as a separator onlapping to the north. A leftward drift on a gamma ray well log, can indicate, for example, that the facies are clean, sandier, or less radioactive. A leftward drift, in some cases, can indicate a fall in base-level to provide a clean environment. The upper (U) forced regressive system 410 has a unique and sharp drift to the left over the entire basin, whereas the lower (L) regressive system 412 has several para-sequences gradually drifting to the left. The lower regressive system is dominated by several re-activation surfaces, which either explain the resumption of dune stacking or a subtle change in wind direction. Similarly, the underlying glaciated system 420 has several stacking patterns which are strongly regressive & erosive (leftward drift), whilst the other are potentially flooding events (strongly drifting to the right) during an interglaciated periods.

The example in FIG. 4 illustrates a very regional stratigraphic correlation section of a clastic continental setting. Conventional correlation of the illustrated succession can be very challenging. However, with an implementation of the method 200, it becomes evident that most of the studied intervals (e.g, 410, 412, 414, 420) may preserve the native depositional style and vertical stacking patterns (e.g. transgressive/regressive or aggregational). For instance, the lower glaciated margin contains a sharp contact at the top, which is triggered soon after the glaciated front turns into a regional interglaciated margin. Similarly, the aeolian dune fields can be separated easily and they carry at least two dominant trends: lower transgressive (TR) whilst the upper normal regressive (NR) an both can form stacked aeolian dune reservoirs. The Upper (U) unit 410 maintains its regressive nature regionally with a thin transgressive trend 414 separating the lower massive dune fields from overlying sheeted dune fields.

FIGS. 5A-5B show a comparison between a conventional method and an example implementation of the method 200 for a highstand carbonate shelf that aggrades (Agg) and progrades (Prog) towards the east. FIG. 5A shows the results of a conventional pattern-based correlation. The identification criteria are determined from the set of porosity logs on the right 512 for each well in the figure. The left drift of these logs can be an indication of a porous zone while a right drift can indicate a non-porous or tight zone. When the base/top is clear in the gamma ray log on the left 510, the decision is made accordingly. In conventional lithostratigraphic interpretation, the zones are considered the same (e.g., a=b) because of the blocky response of the porosity logs, for example, the porous zone 516 in Well G 518. One problem with the interpretation of the conventional approach is an assumption of a blocky gamma ray log and a mixed approach (e.g. using 2 or more logs in combination such as a porosity log and a gamma ray log). When the approaches are mixed, a sequence stratigraphic surface may define a lithofacies contact in one area and in another area the same surface may define a relative geologic event/time.

FIG. 5B shows the results from the example implementation of the method 200 for the same set of well logs as in FIG. 5A. With the predicted trend log 520, it becomes evident that the upper sequence 522 is actually very different than the lower sequence 524. The lower sequence 524 forms a bank margin and fades away eastward with time-equivalent deep-water facies. While the upper sequence 522 of flaps and continues to grow as a low angle prograding margin. The upper sequence improves towards the east as it defines the ultimate shelf edge. The lower sequence 524 contains a grain supported shelf that appears extensive and easily correlated on conventional logs displayed in this panel. However, the upper sequence 522 contains a porous zone that is well developed to the east 516 whereas it is poorly developed to the west 528. It cannot be easily correlated on conventional logs because of thickness variations and absence of patterns. For example, in FIG. 5B, tracing the porous zone in the upper sequence 522 from the east 516 to the west 528, the shape of the porosity log changes within the same zone. The predicted trend log illustrates a consistent trend of the upper sequence 524, which provides a visual aid to correlate the equivalent top at Well-A 526 and understand the sequence stratigraphic architecture and depositional history.

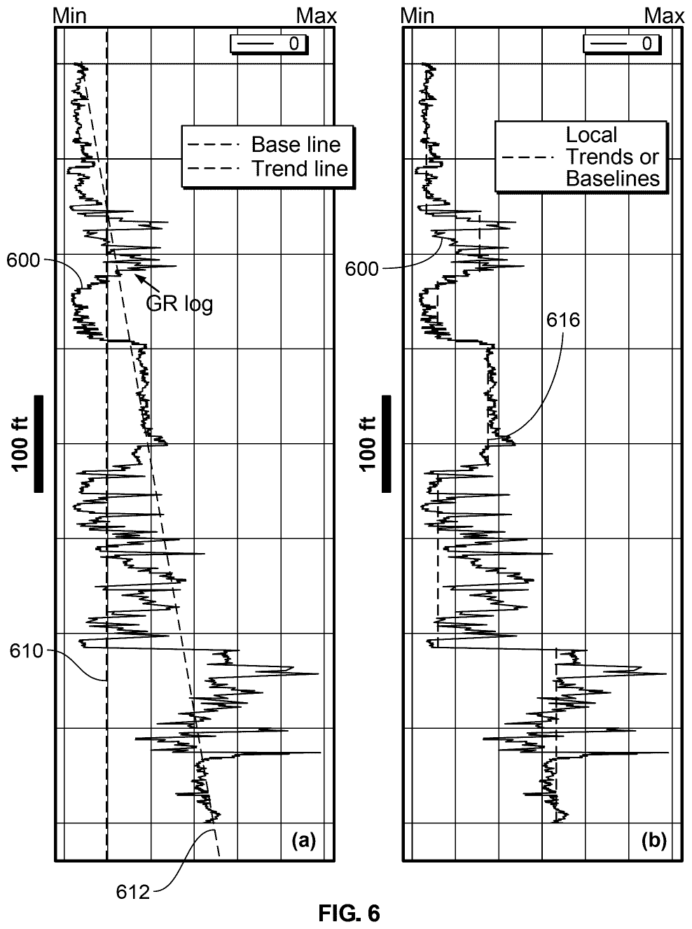

FIG. 6 shows an example gamma ray (GR) log 600 demonstrating conventional methods of utilizing wireline log data. One common method of analyzing a wireline log is defining a standard baseline 610 as a trend across a set of wireline logs. Log motifs can be correlated to connect multiple wells on a regional and local scale. Baseline trends 610 are unique value constants (e.g., clean gamma ray base line). The baseline 610 constant can vary zone by zone. The deviation of the log data above the baseline 610 can identify a different rock or mineral and material based correlation may continue over a number of wells. The baseline method assumes that there is a global constant, and the rock of the subsurface formation follows the constant in a realistic way. However, there can be numerous geologic events which can increase or decrease a given mineral content locally. This can lead to an erroneous correlation of a stratigraphic succession.

Trend lines 612 can also be extracted through linear regression or polynomial fitting of the entire log data. This is a simpler mathematical way of defining the trend. The trend fit can be from high to low or low to high, leading into a mixed slope. This can result in inconsistent trends for stratigraphic correlation.

Blocked baselines 616 can add further resolution to a baseline method. This can be done locally or windowed (e.g., zone by zone). Often, the data can be visually inspected to predict vertical blocking or local trend lines.

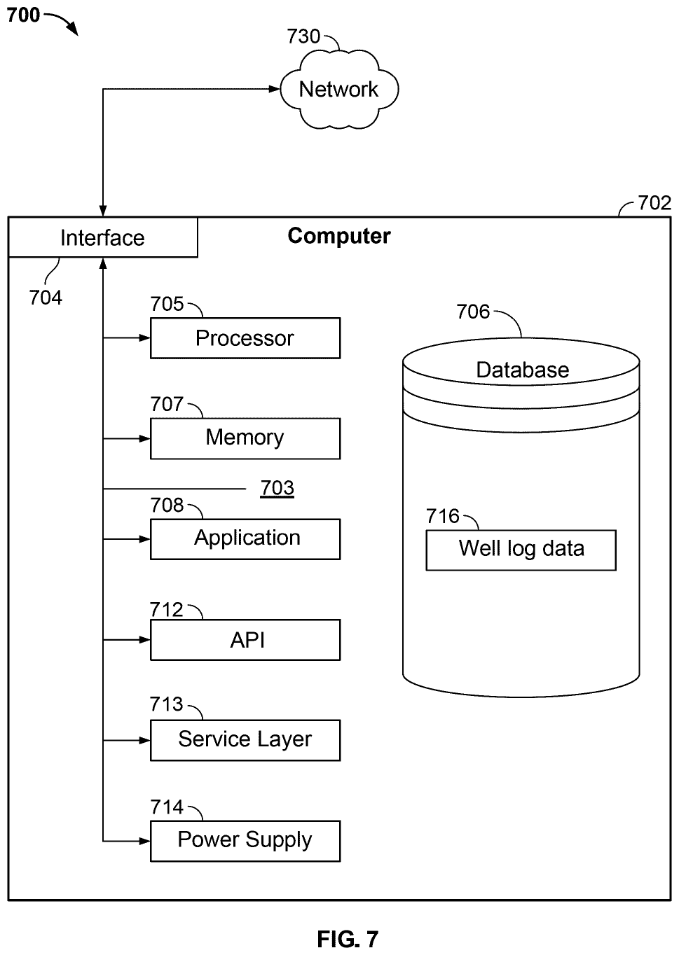

FIG. 7 is a block diagram of an example computer system 700 used to provide computational functionalities associated with described algorithms, methods, functions, processes, flows, and procedures described in the present disclosure, according to some implementations of the present disclosure. The illustrated computer 702 is intended to encompass any computing device such as a server, a desktop computer, a laptop/notebook computer, a wireless data port, a smart phone, a personal data assistant (PDA), a tablet computing device, or one or more processors within these devices, including physical instances, virtual instances, or both. The computer 702 can include input devices such as keypads, keyboards, and touch screens that can accept user information. Also, the computer 702 can include output devices that can convey information associated with the operation of the computer 702. The information can include digital data, visual data, audio information, or a combination of information. The information can be presented in a graphical user interface (UI) (or GUI).

The computer 702 can serve in a role as a client, a network component, a server, a database, a persistency, or components of a computer system for performing the subject matter described in the present disclosure. The illustrated computer 702 is communicably coupled with a network 730. In some implementations, one or more components of the computer 702 can be configured to operate within different environments, including cloud-computing-based environments, local environments, global environments, and combinations of environments.

At a high level, the computer 702 is an electronic computing device operable to receive, transmit, process, store, and manage data and information associated with the described subject matter. According to some implementations, the computer 702 can also include, or be communicably coupled with, an application server, an email server, a web server, a caching server, a streaming data server, or a combination of servers.

The computer 702 can receive requests over network 730 from a client application (for example, executing on another computer 702). The computer 702 can respond to the received requests by processing the received requests using software applications. Requests can also be sent to the computer 702 from internal users (for example, from a command console), external (or third) parties, automated applications, entities, individuals, systems, and computers.

Each of the components of the computer 702 can communicate using a system bus 703. In some implementations, any or all of the components of the computer 702, including hardware or software components, can interface with each other or the interface 704 (or a combination of both), over the system bus 703. Interfaces can use an application programming interface (API) 712, a service layer 713, or a combination of the API 712 and service layer 713. The API 712 can include specifications for routines, data structures, and object classes. The API 712 can be either computer-language independent or dependent. The API 712 can refer to a complete interface, a single function, or a set of APIs.

The service layer 713 can provide software services to the computer 702 and other components (whether illustrated or not) that are communicably coupled to the computer 702. The functionality of the computer 702 can be accessible for all service consumers using this service layer. Software services, such as those provided by the service layer 713, can provide reusable, defined functionalities through a defined interface. For example, the interface can be software written in JAVA, C++, or a language providing data in extensible markup language (XML) format. While illustrated as an integrated component of the computer 702, in alternative implementations, the API 712 or the service layer 713 can be stand-alone components in relation to other components of the computer 702 and other components communicably coupled to the computer 702. Moreover, any or all parts of the API 712 or the service layer 713 can be implemented as child or sub-modules of another software module, enterprise application, or hardware module without departing from the scope of the present disclosure.

The computer 702 includes an interface 704. Although illustrated as a single interface 704 in FIG. 7, two or more interfaces 704 can be used according to particular needs, desires, or particular implementations of the computer 702 and the described functionality. The interface 704 can be used by the computer 702 for communicating with other systems that are connected to the network 730 (whether illustrated or not) in a distributed environment. Generally, the interface 704 can include, or be implemented using, logic encoded in software or hardware (or a combination of software and hardware) operable to communicate with the network 730. More specifically, the interface 704 can include software supporting one or more communication protocols associated with communications. As such, the network 730 or the interface's hardware can be operable to communicate physical signals within and outside of the illustrated computer 702.

The computer 702 includes a processor 705. Although illustrated as a single processor 705 in FIG. 7, two or more processors 705 can be used according to particular needs, desires, or particular implementations of the computer 702 and the described functionality. Generally, the processor 705 can execute instructions and can manipulate data to perform the operations of the computer 702, including operations using algorithms, methods, functions, processes, flows, and procedures as described in the present disclosure.

The computer 702 also includes a database 706 that can hold data for the computer 702 and other components connected to the network 730 (whether illustrated or not). For example, database 706 can be an in-memory, conventional, or a database storing data consistent with the present disclosure. In some implementations, database 706 can be a combination of two or more different database types (for example, hybrid in-memory and conventional databases) according to particular needs, desires, or particular implementations of the computer 702 and the described functionality. Although illustrated as a single database 706 in FIG. 7, two or more databases (of the same, different, or combination of types) can be used according to particular needs, desires, or particular implementations of the computer 702 and the described functionality. While database 706 is illustrated as an internal component of the computer 702, in alternative implementations, database 706 can be external to the computer 702.

The computer 702 also includes a memory 707 that can hold data for the computer 702 or a combination of components connected to the network 730 (whether illustrated or not). Memory 707 can store any data consistent with the present disclosure. In some implementations, memory 707 can be a combination of two or more different types of memory (for example, a combination of semiconductor and magnetic storage) according to particular needs, desires, or particular implementations of the computer 702 and the described functionality. Although illustrated as a single memory 707 in FIG. 7, two or more memories 707 (of the same, different, or combination of types) can be used according to particular needs, desires, or particular implementations of the computer 702 and the described functionality. While memory 707 is illustrated as an internal component of the computer 702, in alternative implementations, memory 707 can be external to the computer 702.

The application 708 can be an algorithmic software engine providing functionality according to particular needs, desires, or particular implementations of the computer 702 and the described functionality. For example, application 708 can serve as one or more components, modules, or applications. Further, although illustrated as a single application 708, the application 708 can be implemented as multiple applications 708 on the computer 702. In addition, although illustrated as internal to the computer 702, in alternative implementations, the application 708 can be external to the computer 702.

The computer 702 can also include a power supply 714. The power supply 714 can include a rechargeable or non-rechargeable battery that can be configured to be either user- or non-user-replaceable. In some implementations, the power supply 714 can include power-conversion and management circuits, including recharging, standby, and power management functionalities. In some implementations, the power-supply 714 can include a power plug to allow the computer 702 to be plugged into a wall socket or a power source to, for example, power the computer 702 or recharge a rechargeable battery.

There can be any number of computers 702 associated with, or external to, a computer system containing computer 702, with each computer 702 communicating over network 730. Further, the terms “client,” “user,” and other appropriate terminology can be used interchangeably, as appropriate, without departing from the scope of the present disclosure. Moreover, the present disclosure contemplates that many users can use one computer 702 and one user can use multiple computers 702.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non transitory, computer-readable computer-storage medium for execution by, or to control the operation of, data processing apparatus. Alternatively, or additionally, the program instructions can be encoded in/on an artificially generated propagated signal. The example, the signal can be a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatus, devices, and machines for processing data, including by way of example, a programmable processor, a computer, or multiple processors or computers. The apparatus can also include special purpose logic circuitry including, for example, a central processing unit (CPU), a field programmable gate array (FPGA), or an application specific integrated circuit (ASIC). In some implementations, the data processing apparatus or special purpose logic circuitry (or a combination of the data processing apparatus or special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example LINUX, UNIX, WINDOWS, MAC OS, ANDROID, or IOS.

A computer program, which can also be referred to or described as a program, software, a software application, a module, a software module, a script, or code, can be written in any form of programming language. Programming languages can include, for example, compiled languages, interpreted languages, declarative languages, or procedural languages. Programs can be deployed in any form, including as stand-alone programs, modules, components, subroutines, or units for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files storing one or more modules, sub programs, or portions of code. A computer program can be deployed for execution on one computer or on multiple computers that are located, for example, at one site or distributed across multiple sites that are interconnected by a communication network. While portions of the programs illustrated in the various figures may be shown as individual modules that implement the various features and functionality through various objects, methods, or processes, the programs can instead include a number of sub-modules, third-party services, components, and libraries. Conversely, the features and functionality of various components can be combined into single components as appropriate. Thresholds used to make computational determinations can be statically, dynamically, or both statically and dynamically determined.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computers suitable for the execution of a computer program can be based on one or more of general and special purpose microprocessors and other kinds of CPUs. The elements of a computer are a CPU for performing or executing instructions and one or more memory devices for storing instructions and data. Generally, a CPU can receive instructions and data from (and write data to) a memory. A computer can also include, or be operatively coupled to, one or more mass storage devices for storing data. In some implementations, a computer can receive data from, and transfer data to, the mass storage devices including, for example, magnetic, magneto optical disks, or optical disks. Moreover, a computer can be embedded in another device, for example, a mobile telephone, a personal digital assistant (PDA), a mobile audio or video player, a game console, a global positioning system (GPS) receiver, or a portable storage device such as a universal serial bus (USB) flash drive.

Computer readable media (transitory or non-transitory, as appropriate) suitable for storing computer program instructions and data can include all forms of permanent/non-permanent and volatile/non-volatile memory, media, and memory devices. Computer readable media can include, for example, semiconductor memory devices such as random access memory (RAM), read only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer readable media can also include, for example, magnetic devices such as tape, cartridges, cassettes, and internal/removable disks. Computer readable media can also include magneto optical disks and optical memory devices and technologies including, for example, digital video disc (DVD), CD ROM, DVD+/−R, DVD-RAM, DVD-ROM, HD-DVD, and BLURAY. The memory can store various objects or data, including caches, classes, frameworks, applications, modules, backup data, jobs, web pages, web page templates, data structures, database tables, repositories, and dynamic information. Types of objects and data stored in memory can include parameters, variables, algorithms, instructions, rules, constraints, and references. Additionally, the memory can include logs, policies, security or access data, and reporting files. The processor and the memory can be supplemented by, or incorporated in, special purpose logic circuitry.

Implementations of the subject matter described in the present disclosure can be implemented on a computer having a display device for providing interaction with a user, including displaying information to (and receiving input from) the user. Types of display devices can include, for example, a cathode ray tube (CRT), a liquid crystal display (LCD), a light-emitting diode (LED), and a plasma monitor. Display devices can include a keyboard and pointing devices including, for example, a mouse, a trackball, or a trackpad. User input can also be provided to the computer through the use of a touchscreen, such as a tablet computer surface with pressure sensitivity or a multi-touch screen using capacitive or electric sensing. Other kinds of devices can be used to provide for interaction with a user, including to receive user feedback including, for example, sensory feedback including visual feedback, auditory feedback, or tactile feedback. Input from the user can be received in the form of acoustic, speech, or tactile input. In addition, a computer can interact with a user by sending documents to, and receiving documents from, a device that is used by the user. For example, the computer can send web pages to a web browser on a user's client device in response to requests received from the web browser.

The term “graphical user interface,” or “GUI,” can be used in the singular or the plural to describe one or more graphical user interfaces and each of the displays of a particular graphical user interface. Therefore, a GUI can represent any graphical user interface, including, but not limited to, a web browser, a touch screen, or a command line interface (CLI) that processes information and efficiently presents the information results to the user. In general, a GUI can include a plurality of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back end component, for example, as a data server, or that includes a middleware component, for example, an application server. Moreover, the computing system can include a front-end component, for example, a client computer having one or both of a graphical user interface or a Web browser through which a user can interact with the computer. The components of the system can be interconnected by any form or medium of wireline or wireless digital data communication (or a combination of data communication) in a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) (for example, using 802.11 a/b/g/n or 802.20 or a combination of protocols), all or a portion of the Internet, or any other communication system or systems at one or more locations (or a combination of communication networks). The network can communicate with, for example, Internet Protocol (IP) packets, frame relay frames, asynchronous transfer mode (ATM) cells, voice, video, data, or a combination of communication types between network addresses.

The computing system can include clients and servers. A client and server can generally be remote from each other and can typically interact through a communication network. The relationship of client and server can arise by virtue of computer programs running on the respective computers and having a client-server relationship.

Cluster file systems can be any file system type accessible from multiple servers for read and update. Locking or consistency tracking may not be necessary since the locking of exchange file system can be done at application layer. Furthermore, Unicode data files can be different from non-Unicode data files.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

A number of embodiments of these systems and methods have been described. Nevertheless, it will be understood that various modifications may be made without departing from the spirit and scope of this disclosure. For example, in some implementations, the well log may be denoised and smoothed before calculating the predicted trend line while in other implementations, these steps may be omitted. Accordingly, other embodiments are within the scope of the following claims.

What is claimed is:

1. A method for correlating stratigraphic sequences in a subsurface formation, the method comprising:
measuring a property of the subsurface formation at a plurality of wells using a logging tool;
storing values of the measured property in a well log for each well of the plurality of wells;
for each well of the plurality of wells, generating a predicted trend log from the well log for that well, the generating comprising:
selecting, based on a sliding window, a set of maximum values and a set of minimum values of the property in the well log;
computing, based on the set of maximum values and the set of minimum values, a set of mean values of the property;
estimating, based on the set of mean values and the values of the property in the well log, a mean drift trend;
configuring a recursive filter, the configuring based on a least squares fit of the set of mean values and the values of the property in the well log;
calculating a relative trend log by convolving the recursive filter with the mean drift trend; and
calculating a predicted trend log by integrating and normalizing the relative trend log; and
rendering, on a user interface, a cross-section of the subsurface formation that is based on the predicted trend logs for the plurality of wells rendering, on a user interface, a cross-section of the subsurface formation based on the predicted trend logs for the plurality of wells.

2. The method of claim 1, the generating further comprising, smoothing the set of maximum values and the set of minimum values before computing the set of mean values for wells of the plurality.

3. The method of claim 2, wherein the smoothing comprises using a one dimensional gaussian filter.

4. The method of claim 1, wherein the property is a facies-dependent property.

5. The method of claim 4, wherein the logging tool comprises a spectral or gamma ray logging tool.

6. The method of claim 4, wherein the well log comprises a resistivity, sonic data, or both.

7. The method of claim 1, the generating further comprising, applying a de-spiking algorithm to the values of the property in the well log.

8. The method of claim 1, further comprising, identifying correlations between predicted trend logs of the plurality of wells.

9. One or more non-transitory computer-readable media storing instructions for correlating stratigraphic sequences in a subsurface formation, the instructions executable by at least one processor to cause the at least one processor to perform operations comprising:
accessing, from a data store, values of a measured property of a well log, the values being accessed for each well of a plurality of wells;
for each well of the plurality of wells, generating a predicted trend log from the well log for that well, the generating comprising:
selecting, based on a sliding window, a set of maximum values and a set of minimum values of the property in the well log;
computing, based on the set of maximum values and the set of minimum values, a set of mean values of the property;
estimating, based on the set of mean values and the values of the property in the well log, a mean drift trend;
configuring a recursive filter, the configuring based on a least squares fit of the set of mean values and the values of the property in the well log;
calculating a relative trend log by convolving the recursive filter with the mean drift trend; and
calculating a predicted trend log by integrating and normalizing the relative trend log; and
rendering, on a user interface, a cross-section of the subsurface formation that is based on the predicted trend logs for the plurality of wells.

10. The one or more non-transitory computer-readable media of claim 9, the generating further comprising, smoothing the set of maximum values and the set of minimum values before computing the set of mean values for wells of the plurality.

11. The one or more non-transitory, computer-readable media of claim 10, wherein the smoothing comprises using a one dimensional gaussian filter.

12. The one or more non-transitory, computer-readable media of claim 9, wherein the property is a facies-dependent property.

13. The one or more non-transitory, computer-readable media of claim 12, wherein the well log comprises a spectral or gamma ray well log.

14. The one or more non-transitory, computer-readable media of claim 12, wherein the well log comprises a resistivity, sonic data, or both.

15. The one or more non-transitory, computer-readable media of claim 9, the generating further comprising, applying a de-spiking algorithm to the values of the property in the well log.

16. The one or more non-transitory, computer-readable media of claim 9, the operations further comprising, identifying correlations between predicted trend logs of the plurality of wells.
